(19) United States
(12) Patent Application Publication
(10) Pub. No.: US 2007/0174459 A1
(43) Pub. Date: Jul. 26, 2007

(54) Device and method for allocating separate bandwidths to multiple virtual users

(76) Inventor: Amichai Lesser, Hoboken, NJ (US)

Correspondence Address: PEARL COHEN ZEDEK LATZER, LLP, 1500 BROADWAY 12TH FLOOR, NEW YORK, NY, 10036, US

(21) Appl. No.: 11/339,831

(22) Filed: Jan. 26, 2006

(51) Int. Cl. G06F 15/173

(52) U.S. Cl. 709/226

(57) ABSTRACT

A device and method of designating a range of virtual IP addresses, and allocating to such addresses separate bandwidths over which virtual users may connect to a virtual network.

### FIELD OF THE INVENTION

The present invention generally relates to computer network emulation. More particularly, the present invention relates to a system and method for allocating separate bandwidths to multiple virtual users of a network.

### BACKGROUND OF THE INVENTION

Testing performance functions of a network may be facilitated by the transmission of data over connections between virtual components of a virtual network. Constraints such as bandwidth, latency, lag, jitter and others may be worked into the connections, and performance criteria may be evaluated in the presence of such constraints. To properly emulate a network with a multitude of users whose network connections may have varying constraints, it may be necessary to add a great many virtual users to a virtual network. Creating or designating such large numbers of virtual clients may be time-consuming and tedious. Furthermore, tracking the constraints applied to a large number of virtual clients for purposes of for example evaluating network performance faced by such clients may be difficult and complicated.

### SUMMARY OF THE INVENTION

Embodiments of the invention include a device and method of designating users on a virtual network that includes designating a range of IP addresses to be assigned to several users on a virtual network, and allocating a first virtual bandwidth capacity to a first virtual user and a second virtual bandwidth to a second virtual user. In some embodiments, the allocated bandwidth may be a known bandwidth that may approximate a bandwidth of a connection modality to a network, such as for example ADSL, cable modem, T1, and dial-up modem connections. In some embodiments, a separate bandwidth may be allocated for an uplink and a downlink. In some embodiments, a data flow over a network such as a flow of data to or from a user may be measured. Such measurement may include for example a throughput rate and/or an average throughput rate. In some embodiments, a queue may be defined or allocated to one or more virtual users. In some embodiments, one or more instructions may designate a range of IP addresses, load such addresses in a table and allocate a virtual bandwidth to one or more of such IP addresses. In some embodiments, one or more of such users may access a network through one or more gateways or network access providers.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a conceptual illustration of components that may be used in creating a virtual network, in accordance with a preferred embodiment of the present invention;

FIG. 2 illustrates connections of a virtual network in accordance with a preferred embodiment of the present invention;

FIG. 3 is a table of IP addresses and network connectivity constraints in accordance with an embodiment of the invention; and

FIG. 4 is a flow diagram of a method in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein

Unless specifically stated otherwise, as apparent from the following discussions, it is appreciated that throughout the specification, discussions utilizing terms such as “selecting,” “processing,” “computing,” “calculating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein.

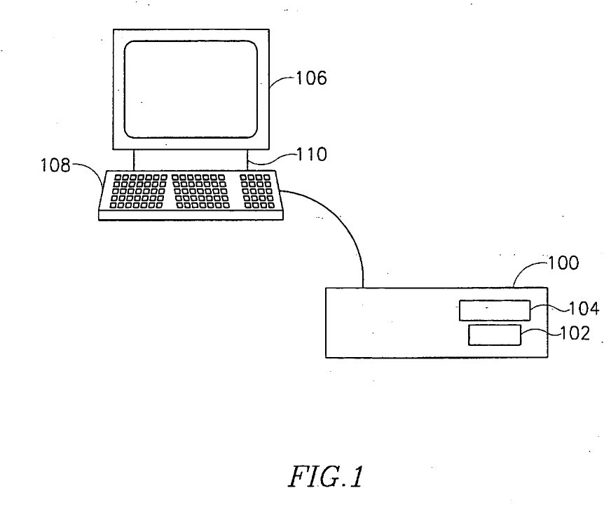

Reference is made to FIG. 1, a conceptual illustration of components that may be used in creating a virtual network, in accordance with a preferred embodiment of the present invention. In some embodiments, components that may be used in creating a virtual network may include for example a network appliance 100, such as a VE Network Appliance available from Shunra Software Ltd. of Kfar Sava, Israel, or an appliance that may be available from Packetstorm Communications Inc of Eatentown, N.J. Other appliances may be used. Network appliance 100 may be or include a processor 104 and a memory 102. Processor 104 may among other functions generate one or more calculations to replicate, simulate, emulate or otherwise create transmissions of data over a series of links or virtual connections between virtual points in a network. Memory 102 may be or include for example random access memory, read only memory, flash or non-volatile memory, a disc drive, other magnetic storage medium or other mass data storage medium that may record and store data on network connections in a virtual network. In some embodiments, processor 104 may calculate performance metrics for data that may be transmitted over a virtual network to or from one or more points on the virtual network. In some embodiments, a metric may include for example an average throughput rate of data transmitted to or from one or more points or users connected to a virtual network. Memory 102 may store for example connection constraints such as a lag, latency, utilization, bandwidth, packet loss and other characteristics of a connection or network point. In some embodiments, memory 102 may store for example an IP address of one or more points or users of a network or virtual network as well as various network connectivity constraints that may be applied to such IP addresses.

A display 106 may display for example real time or collected representations of a structure of a virtual network and one or more constraints of points on such network. In some embodiments, a display may include a user interface that may allow a user or operator to add, delete, replace or alter connections on a virtual network or characteristics or constraints of such connections or points. A display may be connected to an input device 108 such as for example a keyboard or mouse.

In some embodiments, one or more functions of a network appliance 100 may be included in for example instructions such as for example software instructions that may be executed on a platform such as for example a personal computer or work station 110. In some embodiments, processor 104 and memory 102 may be included in such a platform. Some embodiments may include a separate network appliance 100 in one or more separate units, or may combine network appliance 100 into another unit. Some embodiments may not designate a network appliance 100.

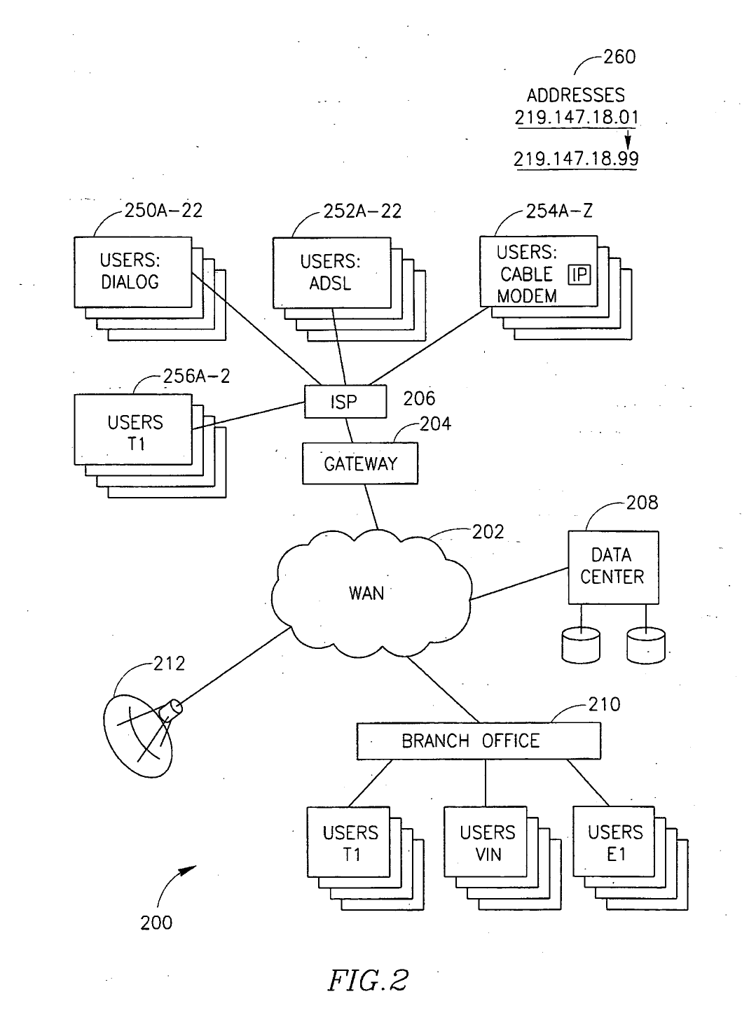

Reference is made to FIG. 2, a conceptual depiction of connections of a virtual network in accordance with a preferred embodiment of the invention. In some embodiments a virtual network 200 may be created in for example a network appliance 100 and may include points that represent or emulate for example a wide wrea network 202, one or more gateways 204, one or more internet access service providers 206 or other providers of connectivity by users to a network 200, a satellite 212 link, a data center 208, an office 210 connection of one or more users of a network 200 and other connections to a virtual network 200. Other configurations of a virtual network 200 are possible and other connections or kinds of connections are possible.

In some embodiments, one or more users 250 of a network may connect to a virtual network 200 over one or more connection modalities. For example users 250A-250ZZ may connect to network 200 over dial-up modems, users 252A-ZZ may connect to network 200 over ADSL lines, users 254A-ZZ may connect over cable modems and users 256A-ZZ may connect over T1 lines. Other connectivity modalities are possible. In some embodiments, a single user such as for example a household or branch office 210 may connect to virtual network 200 over more than one connection modality. For example, a household may include a dial-up connection and a cable modem, or for example a cable modem and an ADSL. Other numbers of IP addresses and users 200 may be used.

In some embodiments, some or each of the connections to virtual network 200 may be designated by one or more IP addresses 260.

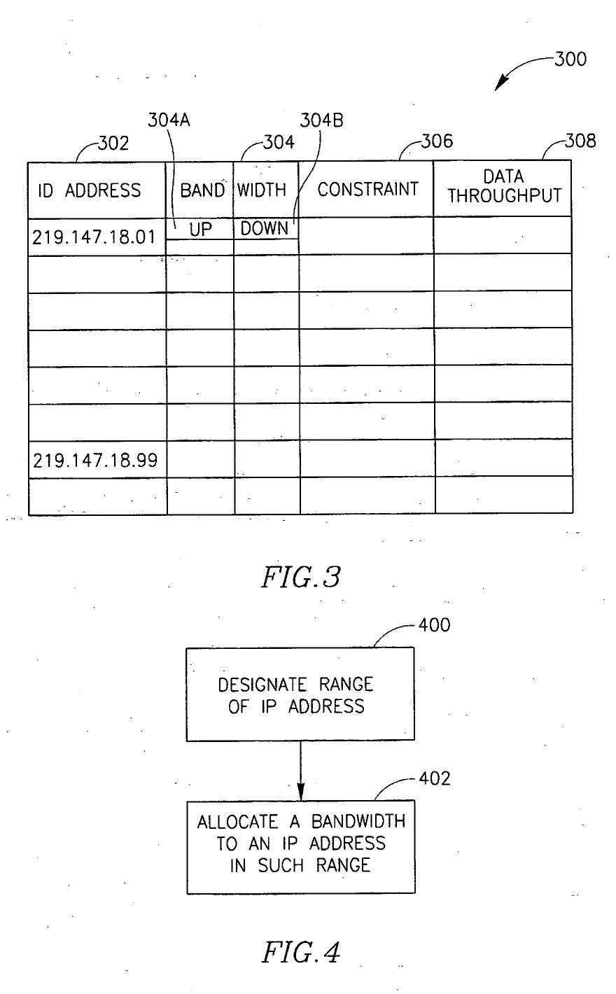

Reference is made to FIG. 3, a table of IP addresses and network connectivity constraints in accordance with an embodiment of the invention. In some embodiments, many virtual users may be designated or created as connected to a virtual network. In some embodiments a range of IP addresses 302 may be designated. For example, IP addresses 219.147.18.01 through 219.147.18.99 may be designated as a range. Other number of separate IP addresses 302 may be used. The range of IP addresses 302 may be read into a table 300, array, chart or other data storage structure. In some embodiments, a first range may be designated, as for example users who connect to a virtual network through for example cable modems. One or more sample bandwidths 304 that may approximate the bandwidths that may be available over cable modem connections may be assigned to the one or more IP addresses 302 that were read into the table 300. Each of such IP addresses 302 as may represent for example a virtual user or a connection to a virtual network, may be assigned its own virtual bandwidth by for example a network appliance or an instruction, so that the bandwidth 304 listed on table 300 corresponds to the relevant IP address 302. Similarly, other network connectivity constraints 306, such as for example jitter, packet loss etc. may be assigned, inserted or read into table 300 and assigned to one or more IP addresses 302 or users listed on table 300. Constraints 306 may be varied within a range of IP addresses 302.

In some embodiments, a designation of bandwidth may be done in for example two or more parts where a first bandwidth 304A is assigned for an upload or uplink from the virtual user to the virtual network, and a second bandwidth 304B is allocated as for example a download or down-link bandwidth of the virtual user from the virtual network.

In some embodiments, a second range of IP addresses 302 may be assigned bandwidths 304 matching those of dial-up modems, and each such IP address 302 may be allocated a separate virtual bandwidth 304 matching those of such modems. Other ranges of IP addresses 302 may be allocated or designated for users 250 who may connect via for example T1, E1 lines or other connection modalities. In some embodiments a processor may vary the constraints 306 that may be assigned to IP addresses 302 in a particular range of IP addresses 302.

In some embodiments, a metric of for example data throughput 308 for one or more of the particular IP addresses 302 may measured by for example an algorithm, and may be input into a column of table 300 corresponding to the respective IP address 302.

In some embodiments, table 300 or some other display of a range of one or more IP addresses 302 and the corresponding bandwidths 304 or other constraints 306, may be displayed for example to an operator.

Reference is made to FIG. 4, a flow diagram of a method in accordance with an embodiment of the invention. In block 400, a range of IP addresses may be designated or otherwise set aside for a first set of virtual users who may be connected to a virtual network. In some embodiments, one or more of the IP addresses in the designated range may be read into a table, array or other data structure so that for example an IP address has a separate entry in the table.

In block 402, a virtual bandwidth capacity may be assigned to each of the IP addresses or virtual users represented by the IP addresses. In some embodiments a particular range of IP addresses may be assigned a known or pre-defined bandwidth that matches the bandwidth of for example a particular modality of network connection. In some embodiment one or more other connection or network constraints may also be assigned to one or more IP addresses within a range of IP addresses. In some embodiments, more than one connection modalities may be assigned to a particular bandwidth.

In some embodiments, one or more or each address in the range of IP addresses may be designated to be connected to a virtual network such that the size of the range of IP addresses that is designated may represent the number of users in a group of users with a particular connectivity modality that may be connected to the virtual network.

In some embodiments, a processor or algorithm may be used to collect one or more metrics of data performance, such as for example a data flow or data throughput, that may be enjoyed by the virtual user listed in the table.

In some embodiments, one or more of the users may be allocated a queue or other segment of memory or network resources, that may store data that had been transmitted to such IP address or virtual user but which had not been able to pass through the bandwidth available to such user.

In some embodiments, one or more instructions issued from for example a user to for example a processor may designate a range of IP addresses, load such range into a table, and allocate a particular bandwidth to such addresses or virtual users.

In some embodiments, some or all of the virtual users represented in the designated range of IP addresses may be connected to a virtual network by for example one or more gateways or through one or more network access providers.

It will be appreciated by persons skilled in the art that embodiments of the invention are not limited by what has been particularly shown and described hereinabove. Rather the scope of at least one embodiment of the invention is defined by the claims below.

I claim:

1. A method of designating users on a virtual network comprising:
designating a range of IP addresses to be assigned to a plurality of users of said virtual network; and
allocating a first virtual bandwidth capacity to a first user of said plurality of users, and a second virtual bandwidth to a second user of said plurality of users.

2. The method as in claim 1, comprising designating a number of users to be connected to a virtual network, where a connection of a user of said number of users to said virtual network has a known bandwidth.

3. The method as in claim 1, wherein said plurality of users of said virtual network, have a connection to said virtual network with a bandwidth approximating a bandwidth of a connection selected from the group consisting of ADSL, cable modem, T1, and dial-up modem.

4. The method as in claim 1, wherein said allocating said first virtual bandwidth capacity comprises allocating a first virtual uplink bandwidth and a first virtual downlink bandwidth.

5. The method as in claim 1, comprising measuring a flow of data over said virtual network to said first of said plurality of users.

6. The method as in claim 1, comprising defining a first queue for said first user of said plurality of users, and a second queue for said second user of said plurality of users.

7. The method as in claim 1, wherein said allocating comprises issuing a single instruction to load said range of IP addresses into a table and a bandwidth to said IP addresses in said range of IP addresses.

8. The method as in claim 1, wherein said plurality of users are connected to a gateway of said virtual network through an access provider.

9. The method as in claim 1, comprising calculating an average throughput of data over said virtual network to said plurality of users.

10. A device comprising a processor to:
designate a range of IP addresses of a virtual network;
assign a virtual bandwidth capacity to each of a plurality of IP addresses within said range of IP addresses; and
calculate a throughput rate of data transmitted over said virtual network to an IP address of said plurality of IP addresses.

11. The device as in claim 10, wherein said processor is to assign a virtual bandwidth for an uplink and a virtual bandwidth for a downlink for said each of said plurality of IP addresses within said range of IP addresses.

12. The device as in claim 10, wherein said processor is to define a queue for each of said plurality of IP addresses within said range of IP addresses.

13. The device as in claim 10, wherein said assigning comprises assigning a bandwidth capacity approximating a bandwidth capacity of a connection modality selected from the group consisting of a cable modem, an ADSL, a T1 and a dial-up modem.

14. The device as in claim 10, wherein said processor is to provide access for said plurality of IP addresses to said virtual network through a single access provider.

15. An article comprising a storage medium, having stored thereon instructions, that when executed on a computer, results in:
designating a plurality of IP addresses to represent a plurality of users in a virtual network; and
assigning a first virtual bandwidth capacity to a first of said users, and a second bandwidth capacity to a second of said users.

16. The article as in claim 15, that when executed on said computer further results in measuring a throughput rate of data transmitted over said virtual network to said first of said plurality of users.

17. The article as in claim 15, wherein said assigning a first virtual bandwidth capacity to said first of said users comprises assigning a virtual bandwidth for an uplink from said first of said users and a virtual bandwidth for a downlink to said first of said users.

18. The article as in claim 15, that when executed on said computer further results in providing access for said plurality of users to said virtual network through a single access provider.

19. The article as in claim 15, wherein said assigning comprises assigning a bandwidth capacity approximating a bandwidth capacity of a connection modality selected from the group consisting of a cable modem, an ADSL, a T1 and a dial-up modem.
